(19) United States
(12) Patent Application Publication
(10) Pub. No.: US 2007/0118861 A1
(43) Pub. Date: May 24, 2007

(54) System and method for delivering graphics received through a cable television system to a digital television

(75) Inventor: Christopher J. Stone, Newtown, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(73) Assignee: General Instrument Corporation

(21) Appl. No.: 11/284,190

(22) Filed: Nov. 21, 2005

(51) Int. Cl. H04N 7/173; H04N 11/00; G06F 13/00; H04N 7/00; H04N 7/16; H04N 7/18; H04N 5/445

(52) U.S. Cl. 725/80; 725/38; 725/133; 725/141; 348/552

(57) ABSTRACT

A set-top box (10) encodes formatted graphics, such as scrolling text of an Emergency Alert System (EAS) message, so that they can be delivered via a compressed digital video interface (14), such as an IEEE-1394 interface, and properly displayed on a digital television set (12) that cannot itself interpret such graphics.

### BACKGROUND

Regular television, radio and other media broadcasts may be interrupted in the event of national or local emergencies so that authorities can disseminate information to the public. In the United States, a semi-automated system for interrupting broadcasts and transmitting emergency alerts is known as the Emergency Alert System (EAS) and is administered by the Federal Communications Commission. Other countries may have analogous systems, and the descriptions in this patent specification are applicable to such systems as well.

EAS emergency alerts that are broadcast via television and similar networks include not only an audible warning message but also digital information. In some cable television systems, the digital information causes the set-top box (STB) connected to the television to automatically tune to a different channel, where the EAS alert can be viewed.

In some instances, the digital information associated with an EAS alert can include codes for formatted graphics, such as a scrolling text box, for display on a television screen or similar device. While the regular broadcast content that a viewer watches on the television is encoded in accordance with either an analog video standard (e.g., NTSC) or a digital video standard (e.g., MPEG-2), EAS alerts and other such formatted graphics are generally encoded in accordance with non-video, graphics-oriented standards. (“MPEG” stands for Motion Picture Expert Group, the body that coordinated the design of the family of standards to which all current digital broadcasting moving images conform.) Also, in the case of a cable television system, such digital information is transmitted from the headend to subscribers via a channel that is separate from the channels carrying the regular broadcast content. This separate channel is commonly referred to as an out-of-band (OOB) channel to distinguish it from the broadcast content band (in-band) channels. In some cases, the separate channel used to carry EAS alerts can be a cable modem channel. In any case, the EAS alert is received by a subscriber's television, which is required to provide the alert to the subscriber in the proper format. If a subscriber has a set-top box (STB), the STB is required to provide the EAS alert to the television.

Most STB's in current use have the capability of inserting graphics into composite video, as is commonly done when an electronic program guide is to be displayed on the screen of a traditional analog television. Likewise, most STB's can insert the scrolling text or similar graphics characteristic of a received EAS alert into the composite video. A problem arises, however, if a subscriber is using a television connected to the STB not via a composite video connection but rather via a compressed digital connection, such as that conforming to the IEEE-1394 serial data bus interface standard. (This standard, promulgated by the Institute of Electrical and Electronics Engineers, is sometimes also referred to as FIREWIRE®, a name that Apple Computer, Inc., an early proponent of the IEEE-1394 standard, uses for its data buses that conform to the standard, and is sometimes also referred to as iLink, a name used by Sony Corporation.)

Digital televisions requiring compressed digital video are most commonly connected to an STB via an IEEE-1394 digital connection. Protocols have been developed for communicating formatted graphics information to a digital television via an IEEE-1394 asynchronous connection separately from the regular content information of the channel being watched, which is delivered to the digital television via an isochronous connection, but most digital televisions in current use do not support those asynchronous protocols. Furthermore, the STB cannot be made to compensate for this shortcoming of current digital televisions because most STB's in current use do not have the capability of simply inserting graphics into the compressed digital video the way they can with analog (e.g., composite) video or uncompressed digital video. Consequently, a subscriber typically cannot view an electronic program guide, an EAS alert, or any other information in the form of such formatted graphics on a digital television connected to an STB via an IEEE-1394 connection.

A limited solution to the problem has been suggested for use with subscribers whose digital televisions support the feature known as Analog-Digital Source Selection, set forth in the CEA-775 standard. (The Consumer Electronics Association, an American National Standards Association (ANSI) accredited body, develops standards for televisions and other consumer video and audio products.) When the STB detects an incoming EAS alert or user action that requires a graphical display, e.g., interactive guide, the STB commands such a television to switch its input source from the IEEE-1394 digital connection to the composite (analog) video connection. Most STB's include both an IEEE-1394 connection and a composite video connection on their rear connector panels, and both can be connected to the television if desired. The STB can then provide the EAS alert or graphical display to the television via the composite video connection. When the EAS alert or graphical display terminates, the STB switches back to the IEEE-1394 connection and continues providing the regular content. This solution is of limited use because most digital televisions in current use do not support the Analog-Digital Source Selection feature.

There are many thousands of STB's in the possession of digital cable television subscribers that do not have the capability of causing the digital televisions to properly display formatted graphics such as EAS alerts and electronic program guides (EPG's), and replacing subscribers' STB's with newer versions having architectures specifically designed to handle formatted graphics via the IEEE-1394 connection would be costly.

### BRIEF DESCRIPTION OF THE DRAWINGS

FIG. 1 is a block diagram of a system for delivering formatted graphics to a television over a digital interface.

FIG. 2 is a block diagram similar to FIG. 1, showing a portion of the system in further detail.

FIG. 3 is a flow diagram of a method for delivering emergency alert messages to a television over a digital interface.

### DETAILED DESCRIPTION

In the following description, like reference numerals indicate like components to enhance the understanding of the invention through the description of the drawings. Also, although specific features, configurations, arrangements and steps are discussed below, it should be understood that such specificity is for illustrative purposes only. A person skilled in the relevant art will recognize that other features, configurations, arrangements and steps are useful without departing from the spirit and scope of the invention.

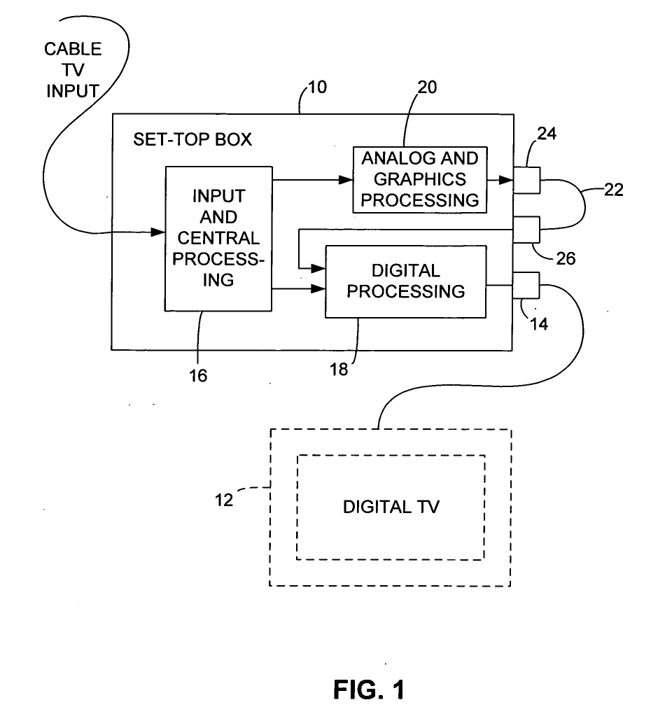

As illustrated in FIG. 1, a set-top box (STB) 10 connected to a cable television system (not shown) is configured to not only deliver regular television programming (content) to a digital television 12 but also to deliver formatted graphics to television 12 if, for example, an Emergency Alert System (EAS) alert or electronic programming guide (EPG) is to be displayed on television 12. (The term “regular television programming” or “regular television content” is intended to refer to anything that a viewer would normally watch on a television, such as television shows and the like received from the cable television system (broadcaster) or read from a digital video disk (DVD) or similar source.) Television 12 is connected to STB 10 via a compressed digital connection such as that conforming to the IEEE-1394 standard. Television 12 does not itself have the capability of displaying formatted graphics, such as EAS alerts having a scrolling text format, received via its IEEE-1394 input. Rather, television 12 is only capable of displaying information encoded in the conventional manner in conformance with the MPEG-2 or similar digital video standard and delivered over IEEE-1394 via an isochronous connection.

As described in further detail below, STB 10 is configured to compensate for the above-described deficiency of television 12 and the IEEE-1394 standard. Specifically, STB 10 is configured to route video information received from the cable television system or network and regular television content information through separate paths to its IEEE-1394 output 14. The regular television content signal is received through the input and central processing circuitry 16 of STB 10, which demodulates it in the conventional manner and provides it to digital processing circuitry 18. Digital processing circuitry 18 in turn provides a signal to television 12 via IEEE-1394 output 14 that is encoded in accordance with the MPEG-2 digital video standard or other suitable format capable of being decoded by television 12. The regular television information is similarly received through input and central processing circuitry 16, but is then routed through analog and graphics processing circuitry 20, which produces a composite video signal and overlays/mixes any graphics (e.g. interactive guide, closed captioning, etc.). The composite video signal is routed through a conventional composite vide RCA cable 22 connected externally to STB 10 between its composite video output 24 and composite video input 26. The cable television subscriber in possession of STB 10 can connect cable 22 as directed by the cable television company, or company personnel can connect it for the subscriber. Alternatively, in other embodiments of the invention, instead of an externally connected cable 22, STB 10 can be modified internally with a jumper, switch or similar connection between composite video output 24 and composite video input 26. In the illustrated embodiment, digital processing circuitry 18 receives the composite signal that loops back into STB 10 via cable 22, digitizes it, encodes it in accordance with the MPEG-2 digital video standard or other suitable format capable of being decoded by television 12, and provides it to television 12 via IEEE-1394 output 14.

The solution described above makes use of composite video output 24 and composite video input 26 of STB 10, which most subscribers who have digital televisions utilizing the IEEE-1394 interface typically leave unconnected to any external video equipment. STB 10 includes composite video output 24 so that subscribers who have analog televisions can connect them to STB 10. Similarly, STB 10 includes composite video input 26 so that subscribers have the option of connecting video equipment that outputs analog (composite) video signals, such as an analog videocassette recorder (VCR), video camera, etc.

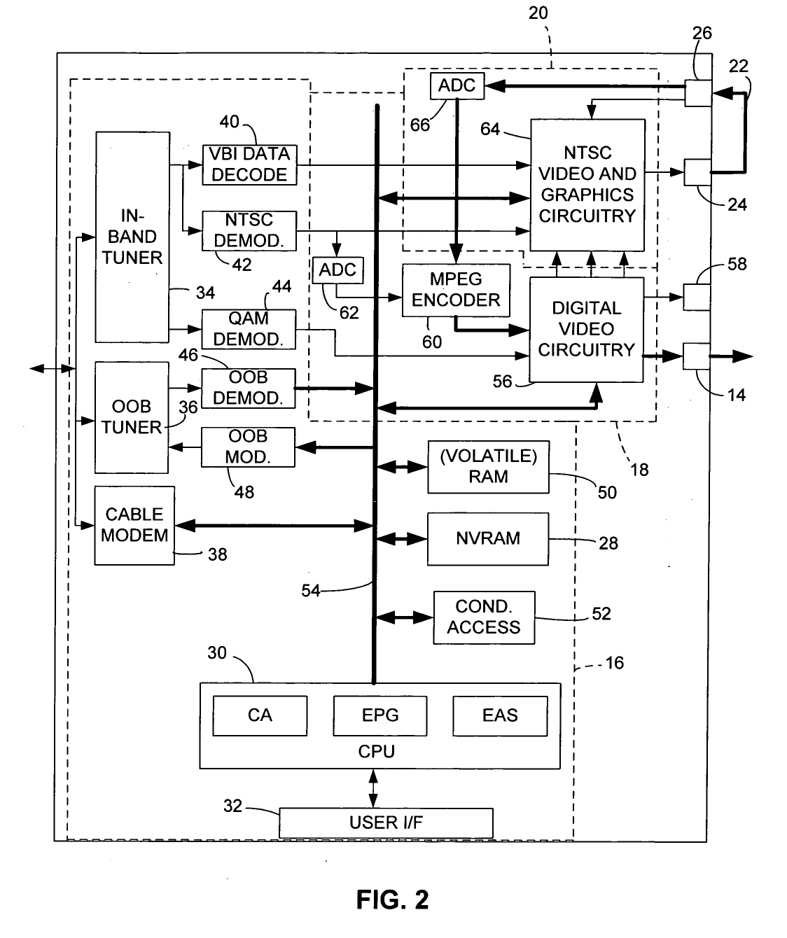

The architecture of STB 10 is shown in further detail in FIG. 2. It should be noted that this general architecture is typical of STB's (e.g., those produced by Motorola, Inc.) that have been in commercial use for several years. Nevertheless, STB 10 is designed to be firmware-configurable or programmable, such that the flow of data among the illustrated elements is dependent upon the manner in which STB 10 is configured or programmed. As known in the art, the cable system operator can transmit programming code from the headend (not shown for purposes of clarity) through the cable system or network to STB 10, which stores the code in non-volatile random-access memory (NVRAM) 28 (e.g., FLASH memory) under control of a central processing unit (CPU) 30. Accordingly, STB 10 can be programmed to configure it in the novel manner described herein. As described in further detail below with regard to the method that is performed, CPU 30 controls both the flow of data and the manner in which certain elements process or otherwise act upon the data. CPU 30 also processes the EAS messages and controls operation of the electronic program guide (EPG) and the conditional access (CA) features. Note that the combination of the programming code and NVRAM 28 or other data storage or transmission medium constitutes a “computer program product” as that term is used in patent claims.

In addition to NVRAM 28 and CPU 30, input and central processing circuitry 16 includes user interface logic 32, an in-band tuner 34, an out-of-band (OOB) tuner 36, a cable modem 38, and various conventional modulators and demodulators 40-48, namely, a vertical blanking interval (VBI) decoder 40, an NTSC video demodulator 42, a quadrature amplitude modulation (QAM) signal demodulator 44, an OOB signal demodulator 46, and an OOB signal modulator 48, for decoding VBI-embedded data, demodulating NTSC video, demodulating digital video, and modulating and demodulating OOB signals, respectively. Working memory 50, which can be random access memory (RAM), is also included for use by CPU 30. Conditional access (CA) logic 52 is also included to ensure that only authorized digital content is displayed, in accordance with the well-known cable television feature known as conditional access. Modulators 40-48, cable modem 38, memories 28 and 50, conditional access logic 52, and CPU 30 are all in communication via a common PCI (Peripheral Component Interconnect) bus 54.

Digital processing circuitry 18, which is also in communication with CPU 30 via PCI bus 54, includes digital video circuitry 56 that can perform decoding, decrypting, demultiplexing, pass-through, and other functions. Digital processing circuitry 18 is connected to the above-mentioned IEEE-1394 output 14 as well as to a digital visual interface (DVI) or High-bandwidth Digital Multimedia Interface (HDMI) output 58. An MPEG-2 encoder 60 is included so that content received in analog format via the cable system or via composite video input 26 can be output in compressed digital format. In the case of analog content received via the cable system, an analog-to-digital converter 62 receives the demodulated video signal from NTSC demodulator 42 and provides it to digital video circuitry 56.

Analog and graphics processing circuitry 20 includes NTSC video and graphics circuitry 64 that can receive demodulated analog video from NTSC demodulator 42, decoded data from vertical blanking interval (VBI) decoder 40, analog video, audio and data signals from digital video circuitry 56, and a composite video signal from composite video input 26. (Note that although the system is described for purposes of illustration in terms of the standards promulgated by the National Television System Committee (NTSC), the body charged with setting television standards in the United States, and bodies such as MPEG, the principles described herein can also be applied to televisions and STB's that conform to standards found in other regions of the world.) An analog-to-digital converter 66 is also included to receive a composite video signal from composite video input 26, digitize it, and provide the resulting digital video signal to MPEG-2 encoder 60. Analog and graphics processing circuitry 20 is in communication with CPU 30 via PCI bus 54.

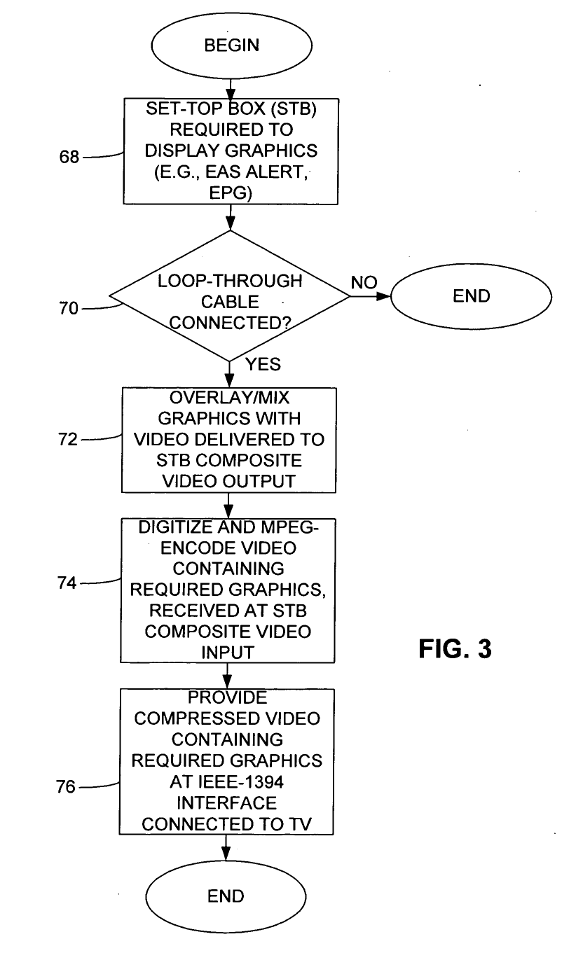

The flowchart of FIG. 3 illustrates an exemplary method of operation for which STB 10 can be configured by downloading the corresponding program code as described above. As noted above, CPU 30 controls the overall process or method, including the routing of data among the elements illustrated in FIG. 2 and the manner in which the controllable ones of those elements act upon the data.

Initially (i.e., before the method illustrated by the flowchart of FIG. 3 is begun), STB 10 may be receiving regular content via the cable television system or other digital video source, e.g., a digital video recorder (DVR), and providing it in compressed digital format to television 12 via the IEEE 1394 interface 14. The cable system, responding in the conventional manner to an EAS alert it receives via other pathways at the cable system headend (not shown), passes the alert on to subscribers with the intent of interrupting subscribers' viewing of the regular content and substituting or overlaying onto the display of the regular content on the television with the EAS alert. For example, the EAS alert transmitted to subscribers may take the form of a digitally encoded message to scroll text (i.e., graphics) across the television screen, with the displayed text advising viewers of an emergency situation. The format for EAS alerts is defined in a government standard and is not relevant to the method and system described herein. Alternatively, the cable system may transmit an electronic program guide (EPG) in response to a viewer's request. In any event, for purposes of illustrating the present invention, what the cable system transmits includes formatted graphics.

At step 68, STB 10 receives such an EAS alert or EPG from the cable television system. Referring back to FIG. 2, the alert can be received, in some instances, via OOB tuner 36, or in other instances, via cable modem 38. (Many STB's currently in use do not have a cable modem.) For purposes herein, it is assumed the received EAS alert or EPG includes formatted graphics (e.g., a scrolling text block) of the type that either the television 12 cannot by itself properly display if provided via IEEE-1394 connection 14 or the STB 10 cannot by itself properly deliver to the TV 12 via IEEE-1394 connection 14 (as an example, the STB does not support On-Screen Display over IEEE-1394 as defined in CEA-775-B). In instances in which it cannot be predetermined whether a received EAS alert will contain such formatted graphics, CPU 30 can test the received EAS alert to determine if it contains codes representing such formatted graphics. (Such a testing step is not shown in FIG. 3 for purposes of clarity and furthermore, such testing is well-known to those familiar with the art of EAS.) If the EAS alert is found not to contain graphics codes, the EAS alert would be handled in an alternative, conventional manner, such as by causing STB 10 to force-tune to a details channel on which the EAS alert is being broadcast. (The delivery of information regarding the details channel and tuning to the details channel is well-known to those of skill in the art and therefore not described herein.) In such a case, it is not necessary to perform the remaining steps set forth below.

As illustrated by step 70, regardless of whether CPU 30 tests for the presence of formatted graphics, it is desirable that CPU 30 determine whether the loop-through cable 22 has been installed, because without cable 22 installed, the method would result in the display of a black screen, which, from a viewer's perspective, may seemingly occur without explanation in the middle of watching something else. CPU 30 can do this in any suitable manner, such as by causing a video signal having identifiable characteristics (e.g., a suitable test pattern) to be output at composite video output 24 and testing what is received at composite video input 26 to see if it has the expected characteristics. If it is determined that no cable 22 is connected, the method terminates, the steps described below are not performed, and instead some other suitable action can be taken. Alternatively, CPU 30 can test for the connection of cable 22 by causing text to be output (i.e., displayed on television 12) that instructs the viewer to interact with user interface 32 in a prescribed manner, such as by pressing a button, if the user has connected cable 22. Although such a test can be performed at essentially any point in the method, it is shown following step 68 for purposes of illustration. Also note that, although desirable, step 70 is not a necessary or required step in the method.

At step 72, CPU 30 causes NTSC video and graphics circuitry 64 to mix/overlay the graphics in analog (composite) video format into the analog (composite) video signal representing the video content that is to be viewed during the duration of the EAS alert. The video content may be the content/channel the user was viewing prior to the reception of the EAS alert or EPG, or the video content may be a details channel tuned to by the STB 10. The output of NTSC video and graphics circuitry 64 feeds composite video output 24, which is connected via cable 22 to composite video input 26. At step 74, the signal that is accordingly received at composite video input 26 is routed through analog-to-digital converter 66 to digitize it and then through MPEG-2 encoder 60 to digitally encode it. (Note that the compressed video may be of other compression types, e.g. H.264, AVC, VC1, MPEG4, Windows Media, Quicktime, etc., where the compression type is supported by both the STB 10 and the TV 12.) At step 76, digital video circuitry 56 receives the resulting encoded digital video information and provides it to IEEE-1394 connection 14.

The result of the above-described steps is that digital television 12 receives a compressed digital video signal from STB 10 via IEEE-1394 connection 14, where the digital television is able to decode and display to the compressed digital video to the end user, where the compressed digital video contains the required graphics (e.g. EAS text scroll, EPG, etc.), which are now properly displayed to the end user. Formatted graphics, such as a scrolling text box, would appear superimposed over any regular broadcast content that may continue to be received via the STB's 10 video tuner front end 16, due to the mixing function of NTSC video and graphics circuitry 64. Although not shown in FIG. 3 for purposes of clarity, when the graphical presentation session terminates, i.e., there are no more graphics to display, television 12 returns to displaying the regular content as it was prior to the event.

It will be apparent to those skilled in the art that various modifications and variations can be made to the above-described method and system without departing from the spirit or scope of the invention. Thus, it is intended that the present method and system cover all modifications and variations that come within the scope of one or more claims and their equivalents. With regard to the claims, no claim is intended to invoke the sixth paragraph of 35 U.S.C. Section 112 unless it includes the term “means for” followed by a participle.

What is claimed is:

1. A method for delivering graphics from a set-top box (STB) connected to a cable television system to a television via a compressed digital interface, comprising:
receiving graphics information from the cable television system;
providing the graphics information to a composite video output of the STB;
receiving the graphics information provided to the composite video output of the STB at a composite video input of the STB;
processing the graphics information received at the composite video input of the STB; and
providing the processed graphics information at the compressed digital interface of the STB connected to the television.

2. The method claimed in claim 1, wherein the compressed digital interface is an IEEE-1394 interface.

3. The method claimed in claim 1, further comprising the step of instructing a subscriber to connect a cable between the composite video output and the composite video input.

4. The method claimed in claim 1, further comprising the step of detecting whether a cable is connected between the composite video output and the composite video input.

5. The method claimed in claim 4, wherein the STB does not provide the processed graphics information at the digital interface if a cable is not connected between the composite video output and the composite video input.

6. The method claimed in claim 1, wherein the step of processing the graphics information comprises:
digitizing the graphics information; and
encoding the graphics information in accordance with a digital video encoding standard interpretable by the television.

7. The method claimed in claim 1, wherein the step of receiving graphics information from the cable television system comprises receiving Emergency Alert Service (EAS) message information.

8. The method claimed in claim 1, wherein the step of receiving graphics information from the cable television system comprises receiving electronic program guide (EPG) information.

9. The method claimed in claim 1, wherein providing the processed graphics information at the digital interface of the STB comprises substituting the graphics information for programming content delivered to the television.

10. A system for delivering graphics to a television via a compressed digital interface of a set-top box (STB) connected to a cable television system, comprising:
input circuitry to receive graphics information from the cable television system;
graphics processing circuitry to provide the graphics information to a composite video output of the STB;
digital processing circuitry to receive the graphics information provided to the composite video output of the STB at a composite video input of the STB and to process the graphics information received at the composite video input of the STB; and
output circuitry to provide the processed graphics information at the digital interface of the STB connected to the television.

11. The system claimed in claim 10, wherein the digital interface is an IEEE-1394 interface.

12. The system claimed in claim 10, wherein the analog-to-digital conversion circuitry includes a connection external to the STB between the composite video output and the composite video input of the STB.

13. The system claimed in claim 10, further comprising detection logic to detect whether an external connection exists between the composite video output and the composite video input of the STB.

14. The system claimed in claim 13, wherein the detection logic prevents processed graphics information from being provided at the compressed digital interface if an external connection does not exist between the composite video output and the composite video input of the STB.

15. The system claimed in claim 10, wherein the digital processing circuitry comprises:
an analog-to-digital converter to digitize the graphics information; and
a digital video encoder to encode the graphics information in accordance with a digital video encoding standard interpretable by the television.

16. The system claimed in claim 10, wherein the graphics information comprises Emergency Alert Service (EAS) message information.

17. The system claimed in claim 10, wherein the graphics information comprises electronic program guide (EPG) message information.

18. The system claimed in claim 10, wherein the graphics processing circuitry substitutes the graphics information for regular television content delivered to the television.

19. A computer program product for configuring a set-top box (STB) connected to a cable television system to deliver graphics to a television via a compressed digital interface, the program being carried on a computer-usable medium, the program comprising:
a code segment for configuring the STB to receive graphics information from the cable television system;
a code segment for configuring the STB to provide the graphics information to a composite video output of the STB;
a code segment for configuring the STB to receive the graphics information provided to the composite video output of the STB at a composite video input of the STB;
a code segment for configuring the STB to process the graphics information received at the composite video input of the STB; and
a code segment for configuring the STB to provide the processed graphics information at the digital interface of the STB connected to the television.

20. The computer program product claimed in claim 19, further comprising a code segment for detecting whether an external connection exists between the composite video output and the composite video input of the STB.
